(19) United States
(12) Patent Application Publication
(10) Pub. No.: US 2012/0331422 A1
(43) Pub. Date: Dec. 27, 2012

(54) Custom Jewelry Configurator

(75) Inventor: Jeffrey High, Davenport, IA (US)

(73) Assignee: Gemvision Corporation, LLC, Davenport, IA (US)

(21) Appl. No.: 13/166,324

(22) Filed: Jun. 22, 2011

(51) Int. Cl. G06F 3/048; G09G 5/00

(52) U.S. Cl. 715/849; 345/634

(57) ABSTRACT

A jewelry configurator is disclosed which permits a consumer or end user to begin with a catalog of jewelry pieces that he is able to then customize and alter in various ways to tailor the piece to his taste, view a rendering of said piece, get a price quote for the piece, and send same directly to manufacture for production.

This application is a National Stage application that claims benefit of Patent Cooperation Treaty application no. PCT/US10/52392 which in turn claimed priority to U.S. Patent application No. 61/250,848 filed on Oct. 12, 2009 both of which are hereby incorporated by reference in their entirety.

### FIELD OF THE INVENTION

The present invention relates to an application for an end-user to create customized jewelry in a virtual environment, render a realistic image in real time, quote pricing of same and submit the design to a manufacturer for production.

### PRIOR ART

In the traditional mode of jewelry design, an end user, typically the customer, either has a conceptualized design in mind for jewelry, or has a representation of a jewelry piece (picture or physical item) that he wishes to have modified in certain ways to achieve a unique appearance and design.

In the current state of the art, the jeweler is faced with two basic options in response to this type of customer request. Either concept drawings can be submitted to an artisan to be rendered to the best of that artisan's ability, or computer-aided design (CAD) programs exist that can be utilized to attempt to convert the concept into a more tangible medium, which is then transferred to a manufacturer for the rendering of the actual piece.

Obvious downsides to the current mode of jewelry design exist, not the least of which is the uncertainty of the end-user's concept actually matching the final rendered piece. These variations can be due to any number of factors, such as manufacturing limitations within the medium, translation of the features of the piece being lost in sizing, spacing or proportion, the artisan's interpretation, the simple oversight or lack of a customer's appreciation of what the design will look like “in the flesh” or any other myriad variations that can cause discrepancies between what the end customer expects and what is actually delivered. The more the variation between that which the end user conceptualizes and what is delivered generally correlates to a similarly increasing trend of customer dissatisfaction. Other limitations include long design times and manufacturing times, extended time of communication between customer and manufacturer, and often, multiple encounters with the artisan to adjust the design.

These issues can lead to substantial customer dissatisfaction and can create problems for the jeweler, such as having to reproduce or adjust pieces to conform to customer expectations. The result is eroding profit margins and loss of repeat business. Furthermore, the time involved in these steps in the traditional mode of jewelry design is extensive for all involved—customer, artisan and jeweler, which, as is well known, leads to increased expenditures on both ends of the transaction.

The present invention of the custom jewelry configurator is thus a much-improved way to deal with the challenges involved in creating and producing custom jewelry pieces as it streamlines the design, ordering and manufacturing process. The configurator can also help those who are less artistically inclined to find a unique and fitting piece by giving them a starting point in the design process as well as the ability to set different parameters to vary the design and see the results of potential changes. This can generally reduce customer surprise, or the variation between that ordered and that delivered, and increase customer satisfaction, thus bolstering the customer/jeweler relationship. The configurator can also render a clearer image to a customer of what their piece is likely to look like, provide real-time quotes of prices to avoid unnecessary and numerous price quotes and streamline the communication link between consumer, jeweler and manufacturer to reduce lead times and, in turn, cost.

All of these aspects of the current mode of jewelry design lead to an increased need for the present novel application with the ability to permit consumers to view, design, quote and order custom jewelry pieces, all of which the herein below described invention addresses.

### OBJECTS OF THE INVENTION

One object of the invention is to provide a jewelry configurator that is easy to operate by a consumer.

An additional object of this invention is to provide a jewelry configurator that reduces lead times of jewelry manufacture.

Another object of this invention is to provide a jewelry configurator that is able to present a consumer with a catalog of available templates from which to start his design.

Yet another object of this invention is to provide a jewelry configurator that is able to provide real time quoting of pricing based on what the consumer has selected in the configurator.

Still another object of this invention is to provide a jewelry configurator that is able to communicate the consumer's design to a manufacturer directly for production.

Other objects and advantages of this invention shall become apparent from the ensuing descriptions of the invention.

### SUMMARY OF THE INVENTION

According to the present invention, a jewelry configurator is disclosed which peimits a consumer or end user to begin with a catalog of jewelry pieces that he is able to then customize and alter in various ways to tailor the piece to his taste, view a rendering of said piece, get a price quote for the piece, and send same directly to manufacture for production.

### BRIEF DESCRIPTION OF THE FIGURES

The accompanying drawings and figures illustrate an embodiment of this invention. However, it is to be understood that this embodiment is intended to be neither exhaustive, nor limiting of the invention. They are but examples of some of the forms in which the invention may be practiced.

FIG. 1 is a diagram showing a selection of settings for an end user to choose from.

FIG. 2 is a diagram showing a rendering of a selected setting picked by a user.

FIG. 3 is a diagram showing how a user may manipulate setting parameters.

FIG. 4 is a diagram showing how a user may manipulate gemstone parameters.

FIG. 4A is a diagram showing how a user may manipulate the number of gemstones in the setting.

FIG. 5 is a diagram showing how a user selects a wearer's appendage for sample viewing of the piece.

FIG. 6 is a diagram showing a virtual wearer's appendage in a sample viewing of the piece.

FIG. 6A is a diagram showing how the virtual wearer's appendage may be manipulated to allow virtual viewing of the piece.

FIG. 6B is another diagram showing how the virtual wearer's appendage may be manipulated to allow virtual viewing of the piece.

FIG. 7 is a diagram showing a high resolution rendering of an end user's selected piece

FIG. 8 shows a high resolution rendering of the piece displayed on a cell phone, with the phone positioned over the user's hand.

FIG. 9 is a flowchart illustrating the process by which jewelry pieces may be selected, manipulated, and rendered.

### BEST MODE OF CARRYING OUT THE INVENTION

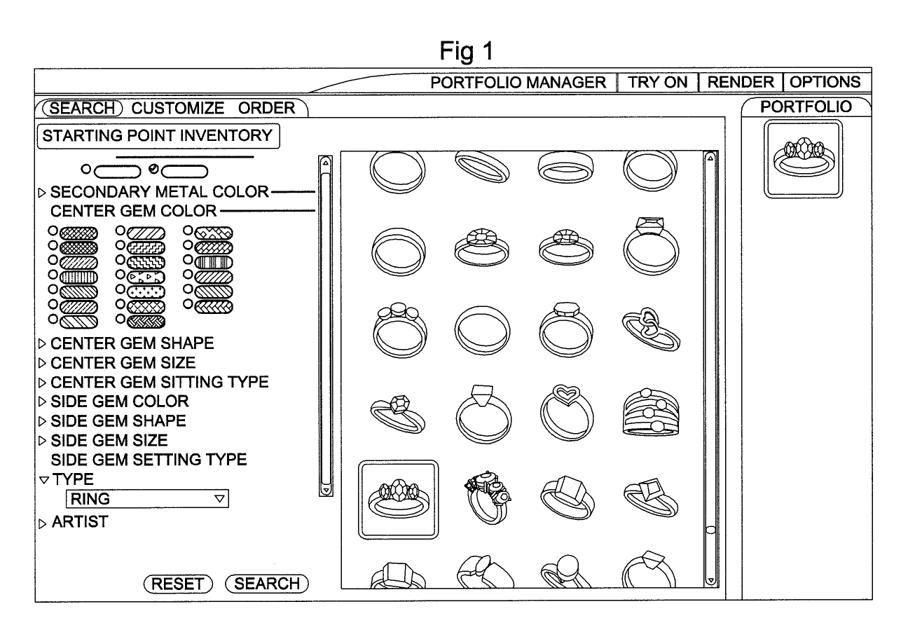

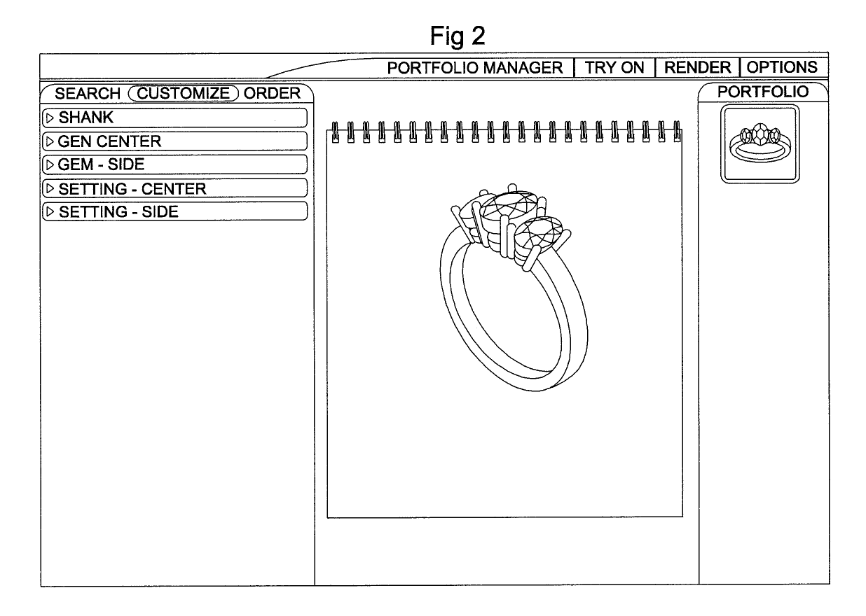

Without any intent to limit the scope of this invention, reference is made to the figures in describing the various embodiments of the invention. FIGS. 1 through 9 depict various aspects of exemplary embodiments of the present invention.

The present invention relates to a jewelry configurator that can be in various forms, such as an appliance, a software application or a consultation method. In the exemplary embodiment below, the invention is a software program which can be driven in either a client-side or server-side configuration such that an end user can access the invention. Preferably, the configurator will be used on a computer having a central processing unit that is operatively connected to a display device such as a monitor and in input device such as a keyboard, a mouse, or a touchscreen.

The configurator begins by presenting a user with a catalog of available settings and materials for these settings based on two pieces of data: one, what a given jeweler or manufacturer wants to be made available for configuration and two, what type of setting an end user may want. For example, if a jeweler has various solitaire settings, two and three stone settings as well as baguette-flanked settings that are available for purchase, the end user can select, or “drill down” from that group to confine his choices to what he may be interested in seeing. See FIG. 1. This unique way of presenting settings enables an end user to see all that which is available and which meets the basic requirements of the user. In this way, no settings are presented that are not available, and the user need not sift through more settings than those which meet his basic requirements.

Piece designs are preferably provided as .jpeg or .png images. When the user selects one by clicking on it with a mouse, a three dimensional (3D) model of the jewelry piece will be loaded into the system. The 3D models are preferably .3DM files, a file format created with the Rhinoceros 3D modeling application (available from McNeel North America, 3670 Woodland Park Ave N; Seattle, Wash. 98103 USA), that have been made to function parametrically—(i.e., a when a parameter is changed, the whole model is changed).

Once a setting is selected from the group mentioned above, the user is presented with a similar list of available gems from which to choose. Depending on the setting, one or more gems may be selected to be set within the chosen setting.

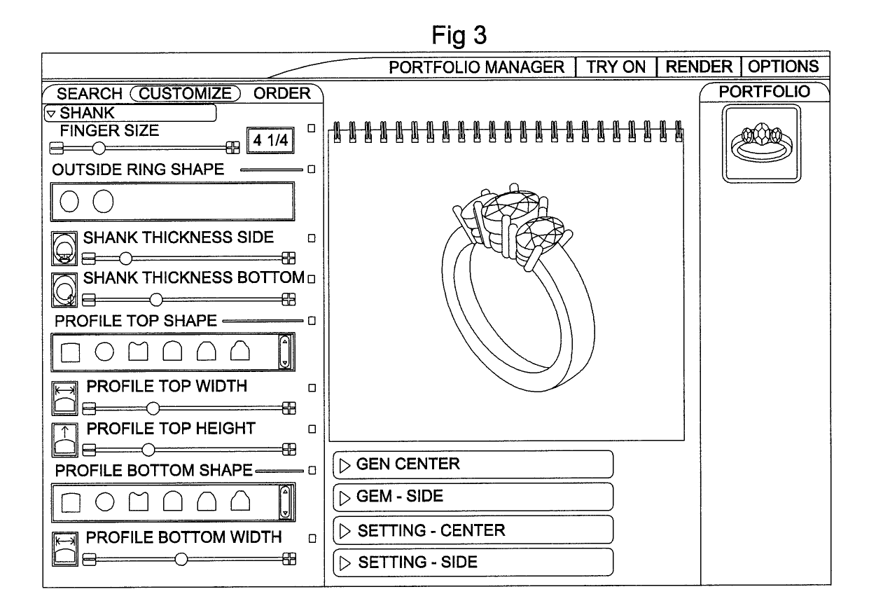

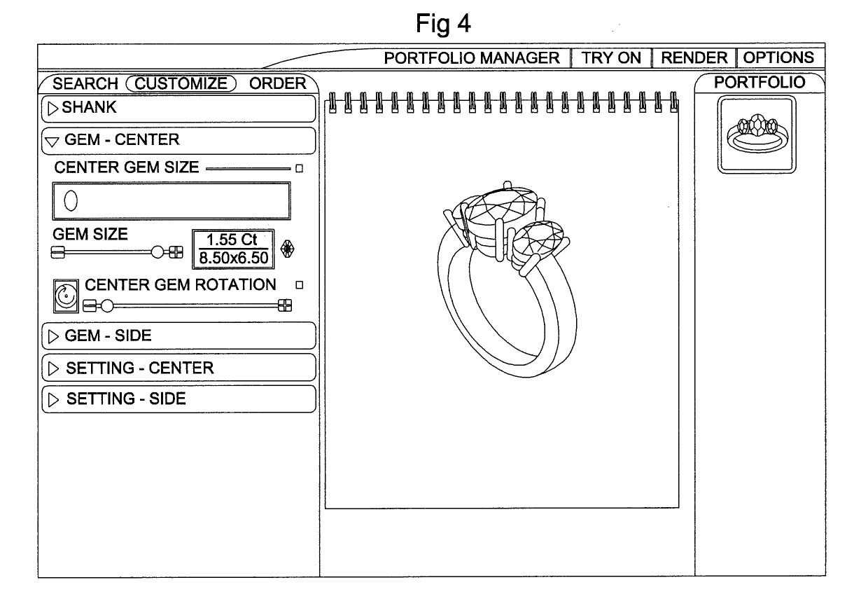

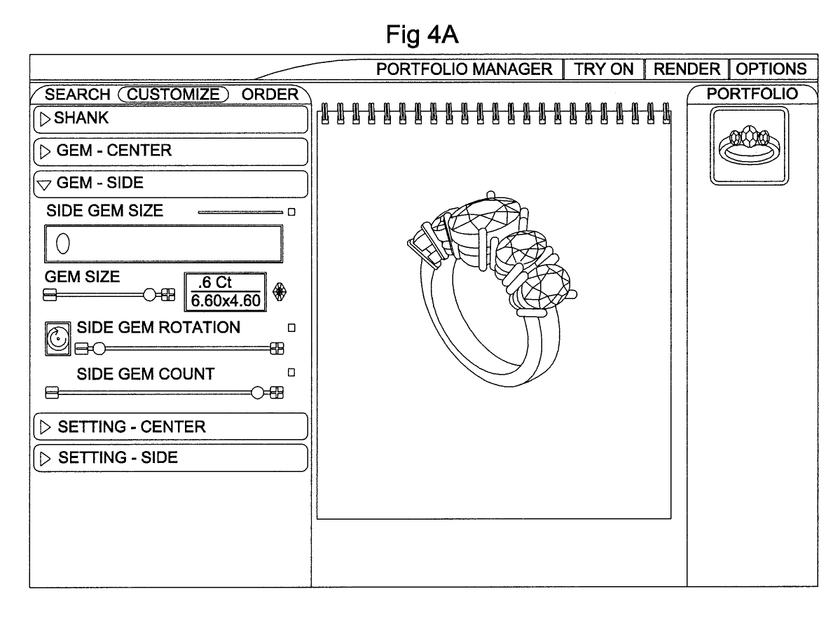

The user is given the option to alter the attributes of the gems contained therein (size, weight, cut, color, type of stone, etc), the materials (such as metal type and karat or grade), placement of gems, number of gems, sizing of the setting (e.g., ring size) and more (depending on the setting type) until the desired look and size are achieved. For each of these alterations, the configurator alters the 3D model, rendering a visual approximation in real time of the piece with the selected attributes as the piece is being altered by the user via the program. See FIGS. 3-4A.

The customization options available to the user will vary from setting to setting. However, some features that will commonly be available for alteration include the side shank thickness, the bottom shank thickness, the shape of the ring exterior, the ring profile top width, the ring profile top height, the ring profile bottom width, gem size, gem shape, gem orientation, gem count and so forth. The user will preferably be provided with a series of slide controls that will allow these characteristics to be adjusted. See, FIGS. 3-4A. Alternatively, the user may manipulate the same characteristics by clicking and dragging on the items in the 3D model with the mouse. The parametrically active .3DM files allow the changes to be rendered in real time for the viewer to see on the screen.

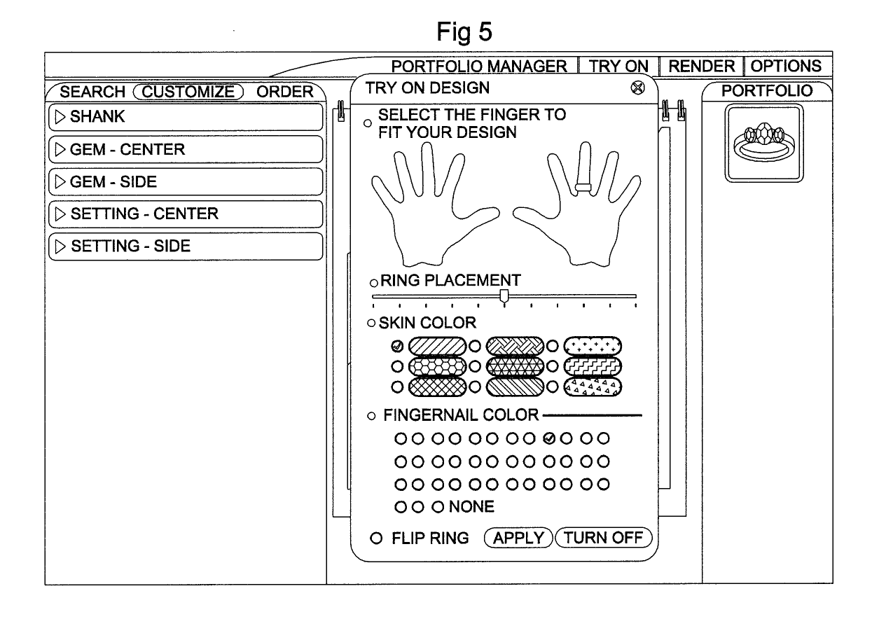

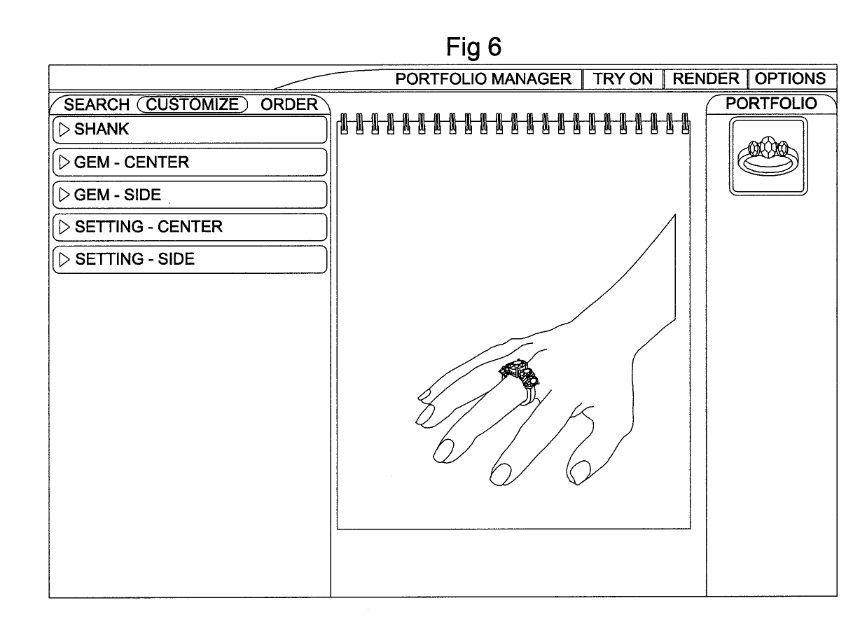

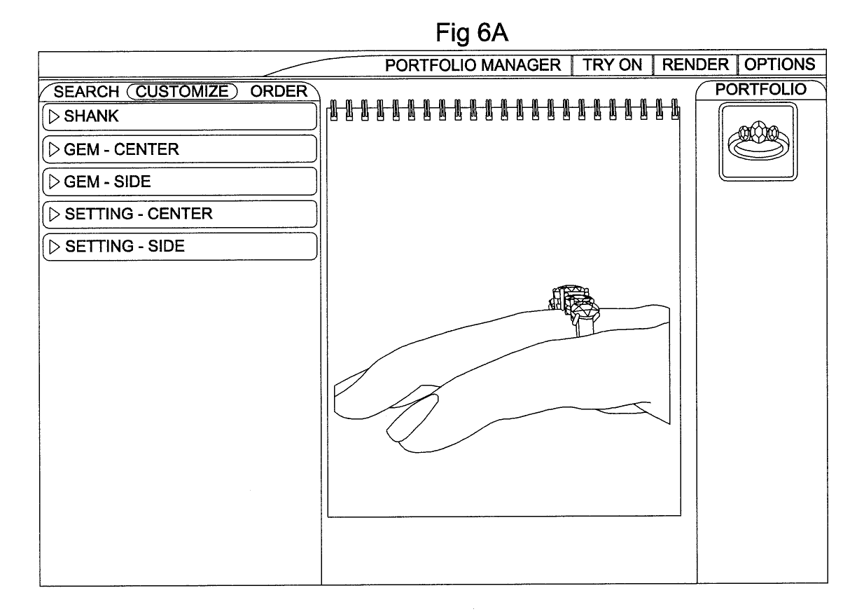

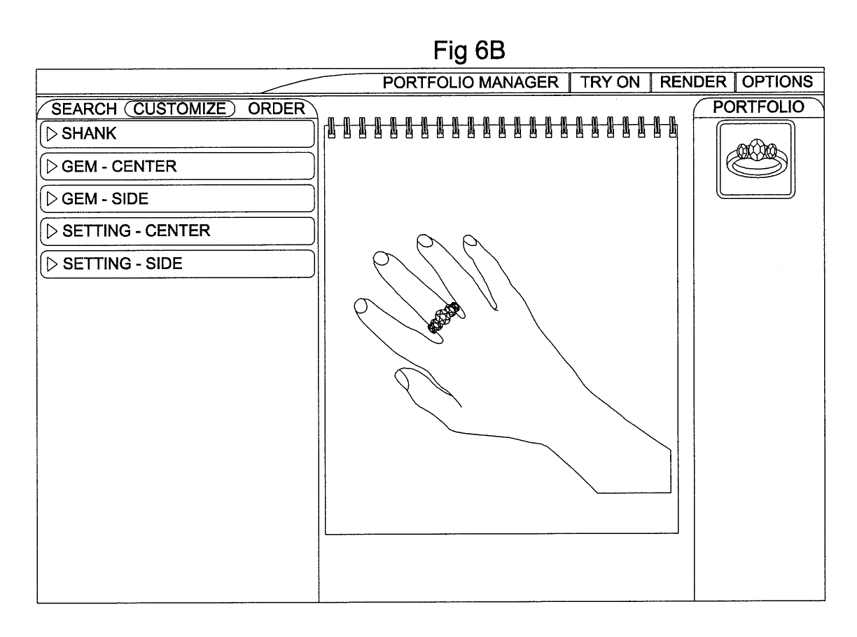

A computer generated image of a human appendage such as a hand or an earlobe may also be created. Preferably, the user will be able to select skin tone and, where appropriate, nail color of the appendage in order to more closely approximate the appearance of the piece on the intended wearer. For a hand, the user may select the finger on which a ring may be placed. See, FIGS. 5-6. Preferably, the appendage will be created as an .stl mesh file.

The software program will then superimpose the approximation of the piece onto the appendage, so that the user may view the approximated piece in a setting that closely the mimics the appearance the piece will have in use. This is accomplished by simultaneously displaying the .stl mesh file of the appendage and the 3D model of the ring or other piece.

The software program will allow the user to rotate the virtual appendage. The superimposed piece will track the rotation of the virtual appendage, allowing the user to view the virtual piece from different perspectives. Likewise, the user can zoom in and out on the virtual piece and appendage. Preferably, this is accomplished using the Rhinocerous 3D program, available from McNeel, identified above.

Although in the preferred embodiment, the piece is rotated together with an appendage, it will be appreciated that the piece could be rendered without the appendage allowing the user to manipulate the image of the piece independently, thereby allowing the user to view the piece from multiple perspectives.

At any time, the user may select a virtual image and create a highly realistic rendering. The software takes the virtual 3D model and creates a “near real” rendering of the piece, and preferably the appendage as well, providing the user with a highly realistic image of the design. Preferably, this is accomplished using a rendering program such as V-ray, available from ASGVIS, LLC of 3430 2^{nd} Street, Suite 400 in Baltimore, Md. 21225. Ideally, this near real rendering will be manipulable; however, because of the processor demands required to both render the highly realistic image and to manipulate it, it may be desirable to prohibit manipulation of the high resolution renderings in current versions of the program. Of course, as processor capacities increase, there may be no reason to prohibit manipulation of the high resolution rendering.

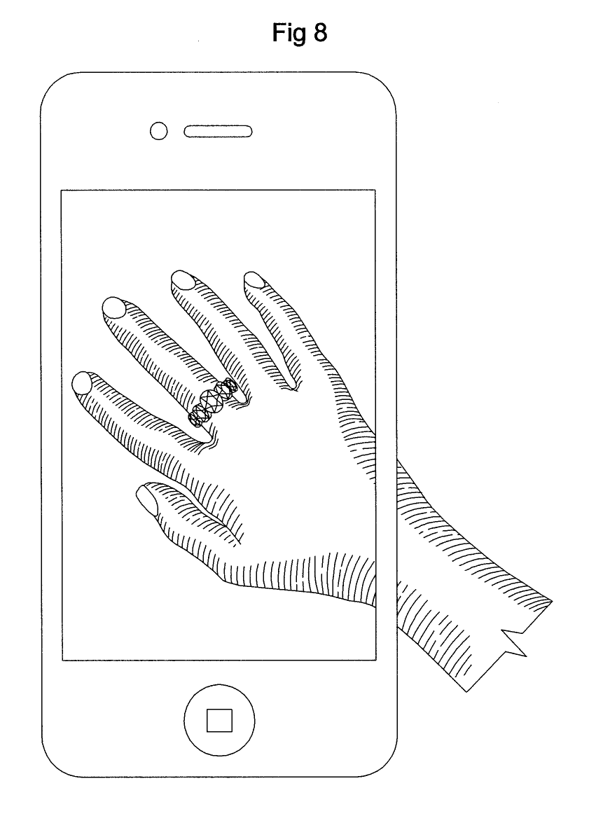

A user can also choose to have an appendage of his or her body imaged, such as with a digital camera integrated with the program. Then, this image can be coupled by the software program with the visual approximation of the piece. The software will then superimpose the visual approximation of the piece onto the image of the user's appendage. In this way, the visual approximation can also include a visual approximation of the intended wearer's body part with the piece on said body part for sampling, such as a wearer's finger, neck, earlobe, etc. so that a more representative image can be seen with the user “virtually” wearing the piece without the need to actually place it into production. This feature is expected to be particularly advantageous in a “smart phone” application. By taking a photograph of the user's hand, for example, with the camera feature available on most smart phones, the user may generate a visual approximation of the piece superimposed onto the image of the user's hand. By placing the phone over the user's hand or other appendage, the user can see what the piece would look like on his or her body. See, FIG. 8.

The visual approximation is also presented by the configurator in a completely scalable view, such that the gems selected will remain true to their size, even when the setting is reduced or increased in size, thus giving the user a much more realistic view of the design which takes into consideration every parameter of the piece. When scaling to a photographic image of the user's appendage, the program may be configured to scale automatically based upon an algorithm and a known or measured distance between the camera and the user's appendage. Alternatively, scaling could be accomplished with reference to an object of known size such as a penny.

When scaling in a three dimensional environment, such as the three dimensional jewelry models or human appendage models, scaling is a function inherent in the 3D program available from Rhinocerous.

The ability to scale is especially valuable in the field of jewelry, since the entire piece is scaled up and down with variations in attributes like ring size, shank type and the like. Being able to visually see how the scaling affects the design, and being able to compensate for those changes immediately and see the visual rendering of the piece is thus a highly beneficial feature of the invention.

It is also important to note that the invention is designed to be programmed to permit a great deal of latitude in the design process, but is also coded such that certain combinations of attributes which are either infeasible or inadvisable are precluded from a user's purview. For example, in a channel set piece, the stones set in such channel would be confined to appropriately sized and shaped stones so that a user would be prevented from submitting an impractical design. Similarly, requesting that an improper number of stones be set into a channel can be avoided as well, to prevent a design which is physically impossible to produce from being submitted. The actual prohitbited alterations will vary from piece to piece. However, it will be appreciated that by precluding alterations in the design that cannot be manufactured, a user can be presented with the maximum configurability and customization available for any given piece, but is essentially protected from wasting his or her efforts designing things which would be impractical or impossible to produce.

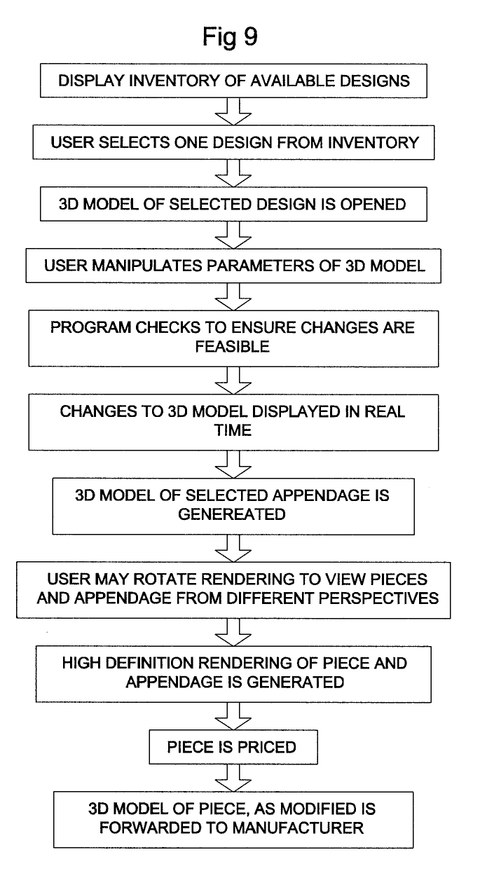

At this stage, the user can select to have a price quote provided to him based on all the attributes selected, so the user can determine if the price is acceptable. Typically, the price will be generated based upon the estimated size and quality of the stone or stones to be included with the piece, plus the estimated quantity, grade (e.g. purity), and the market price of precious metal or other material that will be utilized in the ring. Once finalized and the price is approved, the invention can store the data for the ultimately selected piece, complete with all attributes, in memory for transmission. The end user's data is then collected for purposes of contacting user and delivering the finished product, whereupon this data is then coupled with the above-referenced modeling and material data into a single file vessel, or a unitary file. This single file vessel reduces complexity and the possibility for loss or confusion in the ordering process. See FIG. 9. This file can then be directly transmitted to the manufacturer for production, where the piece can be made.

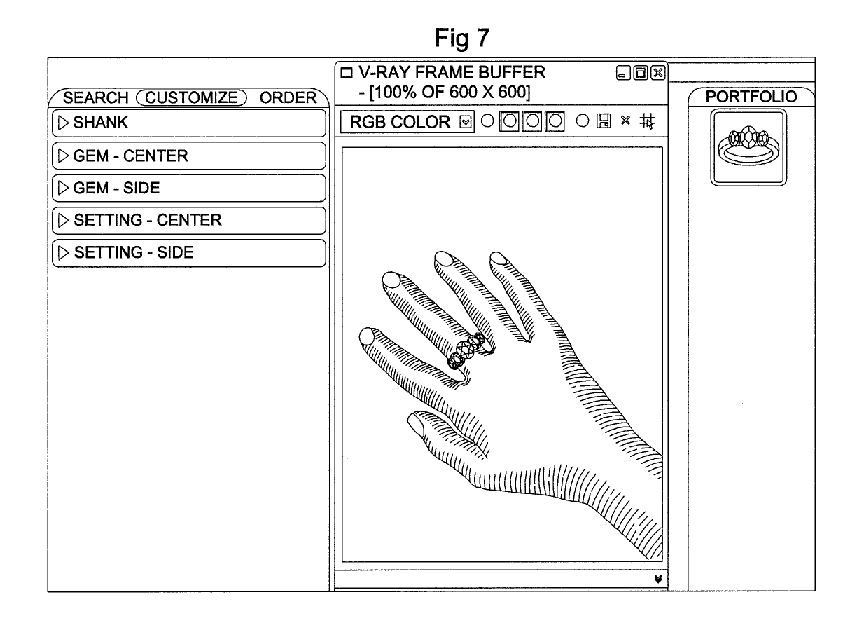

In operation, then, a user enters the application, and is presented with several pieces from which to choose. He may either select one of the presented pieces, or drill down by attribute to a more refined grouping of available settings. At this point, metal choices, gem choices and other attributes are presented for selection by the user. See FIG. 1. The user can then mix and match settings, changing each in a visual environment showing the changes in real time as each selection is made/changed. See FIGS. 3 and 4. If desired, the piece can be viewed on a virtual wearer to sample the piece on an individual. The program is configured to allow the user to manipulate the image of the virtual wearer in order to observe the piece from multiple perspectives. See FIGS. 6-6B. Another visual display can be chosen to display a “near life” visual representation of the piece so the end user can know with relative precision how the piece will appear. See FIG. 7.

The near life representation should be a high resolution image, preferably in a standard bit map format such as .jpeg, .png, and .bmp. For purposes of this invention, “high resolution” refers to an image having a resolution of at least 1000×1000 pixels.

Finally, once the user has settled on an acceptable design, the user can then enter his personal data for ordering and quotation purposes, get a price estimate of the piece he has “virtually” constructed, and if desired, send the information on himself and the 3D model of the piece as well as any other relevant details to a manufacturer, who can then produce and dispatch the product directly to the end user.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

I claim:

1. A method of designing jewelry utilizing a computer having a central processing unit connected to the internet, an input device and a display device operatively connected to said central processing unit, wherein the method comprises:
displaying a plurality of images on a said display device, each said image corresponding to a computer file comprising a three dimensional model of a jewelry piece;
downloading one of said three dimensional models into said central processing unit by selecting one of said corresponding images;
displaying said selected three dimensional model of said jewelry design on said display device;
adjusting the selected three dimensional model by adjusting parameters selected from the group consisting of side shank thickness, bottom shank thickness, exterior shape, the profile top width, profile top height, profile bottom width, gem type, gem size, gem shape, gem orientation, and gem count;
ensuring that the adjustment is not outside or preselected parameters;
displaying the modified three dimensional model on said display device substantially simultaneously with said adjustment;
transmitting said modified three dimensional model to a jewelry manufacturer.

2. A method of designing jewelry according to claim 1 further comprising manipulating said modified three dimensional jewelry model to change the orientation of said three dimensional model and displaying said modified three dimensional model on said display device as said orientation changes.

3. A method of designing jewelry according to claim 1 further comprising downloading a three dimensional model of a human appendage;

4. A method of designing jewelry according to claim 3 further comprising displaying said modified three dimensional jewelry model and said three dimensional model of a human appendage simultaneously on said display device so that said jewelry model appears to be disposed around said human appendage.

5. A method of designing jewelry according to claim 4 further comprising manipulating said modified three dimensional jewelry model and said three dimensional human appendage model to change the orientation of said three dimensional jewelry model and said three dimensional human appendage model, while maintaining the relative orientation of said models to each other and displaying said modified three dimensional jewelry model and said three dimensional human appendage model on said display device as said orientation changes.

6. A method of designing jewelry according to claim 1 further comprising creating a high resolution rendering of the design and displaying said high resolution rendering on said display device.

7. A method of designing jewelry according to claim 1 wherein said modified three dimensional model is transmitted to said jewelry manufacturer via the Internet.

8. A method of displaying a jewelry design utilizing a hand held computer having a central processing unit, a display device operatively connected to said central processing unit, memory operatively connected to said central processing unit and an input device comprising a camera operatively connected to said central processing unit; wherein the method comprises:
taking a photograph of an appendage of a user;
storing said photograph in said memory downloading a high resolution image of a jewelry design to said memory;
accessing said photograph and said high resolution image of a jewelry design in said memory;
merging said high resolution image of said jewelry design with said photograph of said user's appendage in said central processing unit; displaying said merged image on said display device; whereby said high resolution image of said jewelry design appears to be positioned on said appendage.

9. A method of displaying said jewelry design according to claim 8 wherein said jewelry design is scaled relative to said photograph of said appendage, whereby said jewelry design will be depicted in the merged image in its actual relative size as compared to the appendage.

10. A method of displaying said jewelry design according to claim 9 wherein said user positions said display device over said user's appendage.
